(19) United States
(12) Patent Application Publication
(10) Pub. No.: US 2014/0030014 A1
(43) Pub. Date: Jan. 30, 2014

(54) JOINED CONNECTION FOR COMPONENTS BY MEANS OF A LOCATING FIT

(71) Applicant: Thomas Schleeh, Kunreuth (DE)

(72) Inventor: Thomas Schleeh, Kunreuth (DE)

(73) Assignee: Schaeffler Technologies AG & Co. KG

(21) Appl. No.: 14/110,516

(22) PCT Filed: Mar. 12, 2012
(86) PCT No.: PCT/EP2012/054200

§ 371 Date: Oct. 8, 2013

(30) Foreign Application Priority Data
Apr. 11, 2011 (DE) 102011007156.3

(51) Int. Cl. F16B 7/02

(52) U.S. Cl. CPC F16B 7/02
USPC 403/333

(57) ABSTRACT

A joined connection for components by an interference fit of a bush (10) in an opening of a housing (1), wherein the opening of the housing (1) has stepped inner diameters (3 to 5) and the bush (10) has stepped outer diameters (12 to 14), the diameter magnitudes of which are configured so as to decrease in a direction of the joined connection. At least one of the outer diameters (12 to 14) has flattened portions (18) distributed over the circumference.

### BACKGROUND

Joined connections with an interference fit are generally known. If an excessively small overlap between the components exists, this leads to low adhesion forces. High overlaps can lead to breakage of one of the components which are to be interconnectable by means of the interference fit. Therefore, accurate dimensions and high-quality surfaces between the components which are to be connected—e.g. a bush and a housing—are necessary in order to obtain constant adhesion forces. These accurate dimensions of the components lead to expensive production methods.

### SUMMARY

It is therefore the object of the invention to rectify the described disadvantages and to provide an inexpensive production of the components for an interference fit. In this case, it is to be ensured that constant adhesion forces are provided even with dimensions which are not so accurate, wherein no destruction of one of the components is to ensue. The components are furthermore to be inexpensively producible.

The object of the invention is achieved by the opening of the housing having stepped, circular cylindrical inside diameters and the bush having stepped, also circular cylindrical outside diameters, the diameter dimensions of which are designed to reduce in the direction of the joined connection, and by at least one of the outside diameters having flats which are distributed over the circumference. The transitions of the steps of the inside and outside diameters preferably have joining bevels.

The bush can now be pushed into the housing without expenditure of force, and centered there, with clearance until the joining bevels abut. The centering is carried out via the joining bevels in the housing and/or in the bush. As a result of further pressing of the bush into the housing the actual fit of the outside diameter of the bush into the inside diameter of the housing is then carried out. In this case, the number of stepped inside and outside diameters is equal and equally stepped. The number can be optional, provision preferably being made for three steps.

The radial dimensions and steps of the inside and outside diameters are selected so that the mutually facing diameters can be interconnected by means of an interference fit and/or extrusion fit. That is to say that the diameters are selected so that the diameters which match each other are first pressed one inside the other by means of a clearance so that entry of the bush into the housing is long and the actual fit is only short.

All three inside and outside diameters advantageously contribute to the overall fit. It is also possible, however, that for example only the smallest inside and outside diameters and the largest inside and outside diameters have such a such a radial dimension that only these are involved in the fit.

In a further embodiment of the invention, it is proposed that flats are provided on each of the outside diameters of the bush. A simplification of the production of the bush ensues when the flats are incorporated continuously axially parallel to the bush and along it so that a continuous 4-edged profile is created.

The outside diameters of the bush can have a high overlap in relation to the inside diameters of the housing since the outside diameters between the flats are pressed into or embedded into the respective inside diameters of the housing so that by means of a deformation of the inside diameter by means of the outside diameters which act as protrusions a tight connection of the components with each other is effected. The flats can be applied at a plurality of points on the circumference of the outside diameters. According to the proposal, it is a matter of four flats on each stage of the outside diameter of the bush in each case. This does not have to be the case, however. Provision can also be made for more or less than four flats which are spread over the circumference. As a result of the pressing of the bush into the housing and the forcing of the outside diameters, which act as protrusions, into the respective inside diameter, both a frictionally locking and form-fitting connection between the components is effected.

The outside diameters can additionally have grooves or a groove profile on their circumference in order to increase the joined connection and its adhesion force.

In a further embodiment of the invention, it is provided that the bush is produced from a hard material, preferably hardened steel, and the housing is produced as a metal housing from soft material. As a result, the soft material of the housing, as seen in the pressing direction, is especially plastically displaced forwards and to the side by means of the outside diameters without chips being created as a result.

Despite diameter fluctuations of the dimensions of the inside and outside diameters, constant and large adhesion forces are therefore created. Since the high pressure force in a spot plastic deformation of the housing by means of the outside diameter protrusions is relieved, the housing is not destroyed as a result of tensile stress.

The proposed invention can be used in any joined connections between two components. This is particularly favorable in the case of a hard bush and a soft material of the housing, wherein the housing is designed as a magnetic housing. Especially in the case of this embodiment it is important that no loose chips results during the pressing in.

Due to the continuous flats, passages are created between the housing and the bush so that a fluid, e.g. a liquid, can flow along the joined connection.

### BRIEF DESCRIPTION OF THE DRAWINGS

For further explanation of the invention, reference is made to the drawings in which an exemplary embodiment of the invention is shown in simplified form.

In the drawing:

FIG. 1 shows a section through a bush according to the line A-A in FIG. 3,

FIG. 2 shows a section through a wall of the bush on enlarged scale according to FIG. 1,

FIG. 3 shows a view of the bush perpendicularly to the section according to FIGS. 1 and 2,

FIGS. 4 to 6 show a section through a housing and a bush as separate components, during insertion and in the pressed-in state.

### DETAILED DESCRIPTION OF THE PREFERRED EMBODIMENTS

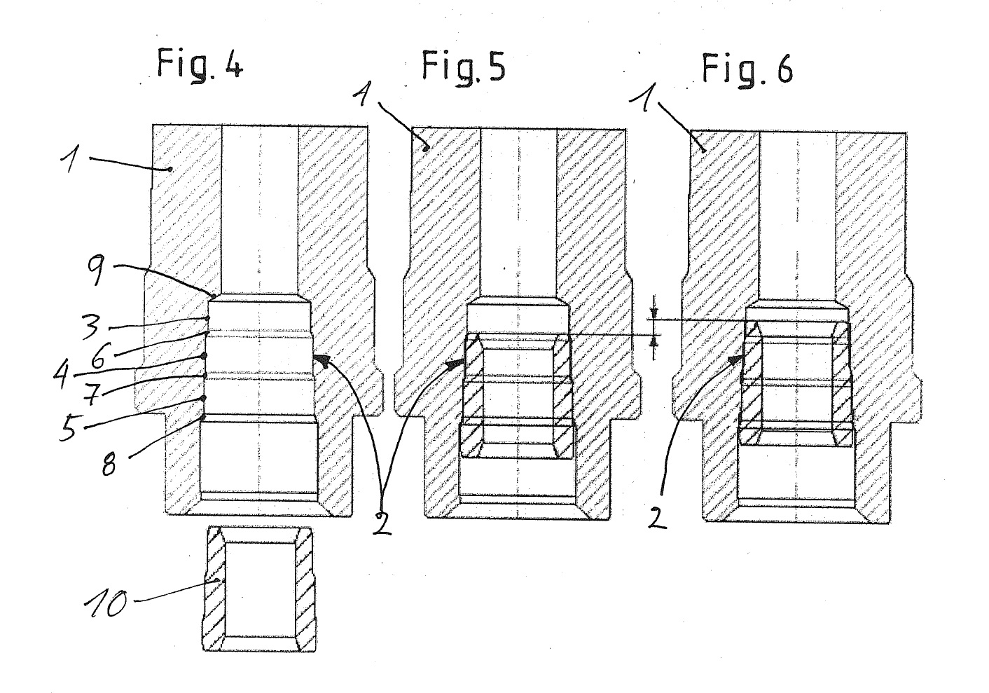

Shown in FIGS. 1 to 6, insofar as being shown in detail, is a housing, designated 1, which has a continuous bore. Adjoining this continuous bore is a stepped bore 2 which has stepped, circular cylindrical inside diameters 3 to 5. Joining bevels 6 and 7 are incorporated between the stepped inside diameters 3 to 5. Furthermore, an entry stage 8 is provided before the largest inside diameter 5 and an end stage 9 is provided at the opposite end of the stepped bore 2.

Also shown is a bush, designated 10, which has a central through-bore 11. The bush 10 has stepped outside diameters 12 to 14 on its outer circumference, wherein joining bevels 15 and 16 are provided between the stepped outside diameters. The bush 10 furthermore has a pressing-in stage 17 at the end of the stepped outside diameter 12.

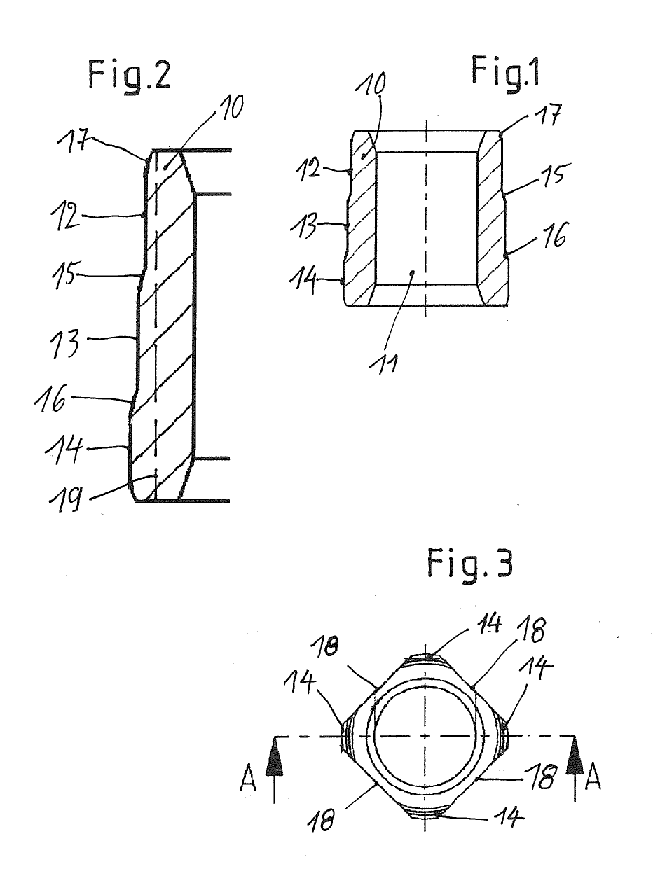

As is also to be gathered from FIG. 3, the stepped outside diameter 14 has four flats 18 on its circumference, which, as is to be gathered from the dashed line 19 in FIG. 2, are constructed with such depth that they extend along the entire bush 10, as well touching on the smallest diameter 12 so that a continuous 4-edged shape is created. It is also possible, however, to provide stepped flats in each case on each outside diameter 12 to 14. After negotiating the clearance fit between the bush 10 and the stepped bore 2, the stepped outside diameters 12 to 14 engage in the stepped inside diameters 3 to 5, wherein the regions of the outside diameters 12 to 14 outside the flats act as protrusions and create a plastic deformation of the material on the inside diameters 3 to 5 of the housing so that the material is deformed forwards and to the side as a bead.

Reference may expressly be made to the fact that a larger number or a smaller number of stepped inside and/or outside diameters and also of the described four flats may be provided. In the region of the outside diameters, protruding grooves can additionally be provided.

### LIST OF DESIGNATIONS

### 1 Housing

2 Stepped bore
3 to 5 Stepped inside diameters
6 and 7 Joining bevels
8 Entry stage
9 End stage

### 10 Bush

### 11 Through-bore

12 to 14 Stepped outside diameters
15 and 16 Joining bevels
17 Pressing-in stage

### 18 Flats

19 Dashed line

1. A joined connection for components, comprising of a bush that fits into an opening of a housing, characterized in that the opening of the housing has stepped, circular cylindrical inside diameters and the bush has stepped outside diameters, diameter dimensions of which are reduced in a direction of the joined connection, and at least one of the outside diameters has flats which are distributed over a circumference thereof.

2. The joined connection as claimed in claim 1, wherein transitions of the stepped inside diameters and of the stepped outside diameters have joining bevels.

3. The joined connection as claimed in claim 1, wherein a number of the stepped inside diameters and of the stepped outside diameters is equal.

4. The joined connection as claimed in claim 1, wherein radial dimensions of the stepped inside diameters and of the stepped outside diameters have an overlap of such size that during joining the diameters which are associated with one another are fastenable to each other by an interference fit or extrusion fit.

5. The joined connection as claimed in claim 1, wherein flats are provided on all of the steps of the outside diameter of the bush.

6. The joined connection as claimed in claim 5, wherein an outside circumference of the bush has continuous flats along it, said flats extend parallel to an axis of the bush and touch on a smallest one of the outside diameters.

7. The joined connection as claimed in claim 1, wherein the joined connection, of the outside diameters which act as protrusions, is formed as a friction-locking and form-fitting connection.

8. The joined connection as claimed in claim 1, wherein the bush is produced from a hard material and the housing is produced as a metal housing from a softer material than the bush.

9. The joined connection as claimed in claim 3, wherein the number of the stepped inside diameters and the stepped outside diameters is three.

10. The joined connection as claimed in claim 4, wherein the stepped outside diameters are constructed as cylindrical.
